(19) United States
(12) Patent Application Publication
(10) Pub. No.: US 2011/0271284 A1
(43) Pub. Date: Nov. 3, 2011

(54) Method of Simulating, Testing, and Debugging Concurrent Software Applications

(75) Inventor: Veronika Simonian, Sunnyvale, CA (US)

(73) Assignee: Veronika Simonian, Sunnyvale, CA (US)

(21) Appl. No.: 13/076,676

(22) Filed: Mar. 31, 2011

Related U.S. Application Data
(60) Provisional application No. 61/343,444, filed on Apr. 29, 2010.

(51) Int. Cl. G06F 9/46

(52) U.S. Cl. 718/102

(57) ABSTRACT

Embodiments of a method of simulating, testing, and debugging of concurrent software applications are disclosed. Software code is executed by a simulator program that takes over some functions of an operating system. The simulator program according to various embodiments is capable of controlling thread spawning, preemption, operating system calls, interprocess communications, signals. Notable advantages of the invention are its capability of testing uninstrumented user applications, independence of the high-level computer language of a user application, and machine instruction level granularity. The simulator is capable of obtaining outcomes of reproducible execution sequences, reproducing faulty behavior, and providing debugging information to a user.

### BACKGROUND OF THE INVENTION

In computationally intensive fields such as computer-aided design, pattern recognition, mathematical modeling, computer gaming, and many others, the speed of computer program execution is of great importance. Programs run faster if computational load is split between multiple cores of a CPU, multiple CPUs, or multiple computers. This widespread approach is known as concurrent programming.

The behavior of a concurrent application is often unpredictable due to the non-deterministic nature of CPU sharing in a multitasking operating system (OS). The main challenge is the occurrence of intermittent failures triggered by a particular execution schedule. An intermittent failure may or may not be captured during a test: software may run successfully for years before a bug reveals itself. Even if such failure is captured, it does not help debugging because there is no mechanism to reproduce it. Few tools are available to developers of multithreaded software; none of them fully addresses the major issue described above: the lack the reproducibility. Yet, in order to fix a bug a programmer must be able to reproduce it. Therefore, there is a need in the field of concurrent programming for effective program testing and debugging methods.

### SUMMARY OF THE INVENTION

Disclosed embodiments of the invented method comprise taking over control of execution of a user application by an OS scheduler simulation program.

Disclosed embodiments of the method work with the compiled user application and are indifferent to the computer language in which a user application may be written. The method does not require code instrumentation.

In an embodiment of the invention, a method of preemptive scheduling is disclosed. The method comprises taking over functions of the OS scheduler by a scheduler simulation program, and giving a command to execute a predetermined number of machine instructions from a compiled user application. The method further comprises preempting a process of a user application at any machine instruction.

In another embodiment of the invention, a method of execution of compiled code instructions by a scheduler simulation program is disclosed. The method comprises executing machine instructions without preemption so long as only one process or thread of an application under test is runnable. Another embodiment of the method comprises executing user-space instructions without preemption so long as all other processes of a user application do not require access to the CPU, for example, they may be waiting for a signal or resource availability.

In yet another embodiment of the invention, a method of non-blocking execution by a scheduler simulation program is disclosed. The method comprises determining that an instruction from a compiled user application is a system call instruction; determining that, if the instruction is executed, the process will block; and stopping the process before such instruction. For example, if an instruction is a system call instruction that attempts to obtain a lock on a resource, execution of the instruction is not allowed by the scheduler simulator if the resource is unavailable.

In yet another embodiment of the invention, a method of creating and reproducing an execution sequence is disclosed. The method comprises taking over functions of the OS scheduler by a scheduler simulation program and allows the scheduler simulation program to make decisions on how many instructions to execute before preemption, which process to resume after preemption or suspension of another process. The method further comprises storing the outcome of execution and information necessary for reconstructing the execution sequence. The outcome of execution may comprise the output of the user application, process flow diagnostic information, program stack, detected abnormal events. A particularly compact method of storing information necessary for reconstructing the execution sequence comprises using pseudo-random number generator.

In yet another embodiment of the invention a method of testing a user application is disclosed; the method comprises performing a plurality of runs; in each run instructions from a compiled user application are executed in a reproducible execution sequence, the information necessary for reconstructing the execution sequence is recorded, and an outcome for each run is obtained. In this embodiment, the method is particularly effective in finding such bugs in a user application that manifest themselves infrequently. In the course of many runs, various execution sequences are generated; the larger the variety of execution sequences, the higher the probability of finding a bug. A run with an unexpected outcome can be exactly reconstructed by the method, hence the buggy behavior can be reproduced for the purpose of debugging.

In yet another embodiment of the invention a method of testing and debugging a user application is disclosed; the method comprises taking over scheduling function of the OS, and performing scheduling of execution when more than one process or thread of the application are runnable; the method further comprises taking over scheduling function of the OS and not performing scheduling when no more than one thread or process is runnable; the method further comprises monitoring system calls regardless of the number of runnable threads or processes running.

In yet another embodiment of the invention a method of testing and debugging a user application is disclosed; the method comprises taking over scheduling function of the OS; the method further comprises allowing a user to select one or more parts of user code for deterministic scheduling of execution while execution of unselected parts is done without deterministic scheduling.

In yet another embodiment of the invention a method of testing a user application is disclosed. The method comprises taking control of events caused by the user application; such events, for example, may be but not limited to: delivery of signals between OS and a process; delivery of signals between a process and other processes; events scheduled by a process such as: going to sleep, waking up from sleep, alarm, parent process awaiting child process completion.

### BRIEF DESCRIPTION OF THE DRAWINGS

FIG. 1 Schematic representations of an application run by an operating system, and an application run by maze.

FIG. 2 An OS scheduler is giving access to CPU to threads and processes.

FIG. 3 A scheduler simulator is giving access to CPU to threads of a user application.

FIG. 4 An instruction pointer points at an instruction before the “clone” system call (view A); next instruction to be executed in the parent process is a “clone” system call (view B); instruction pointers in parent and child processes after the “clone” system call is executed (view C).

FIG. 5 An instruction execution sequence (view A) and an alternative sequence (view B). Sequence A and B differ in the order of completion of child processes.

FIG. 6 Three alternative sequences A, B, and C of mutex acquisitions by two threads. Sequence C results in a deadlock.

FIG. 7 An expanded view of sequence C from FIG. 6 illustrating the non-blocking method of program execution.

FIG. 8 An illustration of non-scheduling of execution by the simulator when not more than one process or thread is runnable concurrently, and non-scheduling outside an interval within user-defined marks.

FIG. 9 A run outcome in “test” mode.

FIG. 10 A run outcome in “reconstruction” mode.

### DETAILED DESCRIPTION OF PREFERRED EMBODIMENTS

In the context of this invention, an “instruction” refers to a single machine instruction executed by a process in user space. Terms “concurrent”, “multiprocessed”, “multithreaded” with respect to a computer program are used interchangeably. As far as the scheduler is concerned, there is no significant difference between a process and a thread, for example, in Linux and other Unix-type OS. A “thread” is a single process, or a thread in a multithreaded process.

“Maze” is the name of an OS scheduler simulation program according to the invented simulation, testing, and debugging method. “Maze”, “the simulator”, “the simulation program”, “scheduler simulator”, “simulation tool” are used interchangeably. “Simulation” refers to taking over operating system functions relevant to execution of an application under test (AUT), such as process scheduling, interprocess communications, system calls and events; and controlling the execution. “Determinism”, “deterministic” refers to the knowledge of exact sequence of execution of a compiled AUT. “A user application”, “code under test”, AUT are used interchangeably.

An “execution sequence” comprises a realizable succession of executed machine instructions, system calls and events which affect the outcome of a concurrent AUT. Such calls and events may be, but are not limited to: delivery of signals between OS and a process or thread, or between threads and processes; events scheduled by a process or thread that belongs to the AUT.

A “run outcome” is information specific to an execution sequence; it may include the output of an AUT, process flow diagnostic information, abnormal events.

An “abnormal event” refers to an unexpected state of a process, for example, but not limited to: a deadlock, illegal memory access, termination of a process by a signal.

“Test mode” is a mode of operation of the simulation tool in which execution of processes of an AUT follows a deterministic and reproducible execution sequence. “Reconstruction mode” is a mode of operation of the simulation tool in which execution of processes of an AUT follows an execution sequence generated in an earlier test run.

Terms “preemptive scheduling”, “preemption” refer to suspension of a process and start or resumption of another process or thread by an OS. In the context of scheduler simulation, “preemption” refers to suspension of a process and start or resumption of another process by the simulator.

A “program counter” is an alternative term for “instruction pointer”; the two are used interchangeably.

A thread is said to be in a “runnable state” if this thread may be running when the OS scheduler—not the invented scheduler simulation program—is performing thread scheduling. For example, consider two threads that are in a non-blocking state. Because of the non-deterministic nature of the OS scheduler, these threads may both be in a running state, or one thread may be in a running state while the other may be a non-running state. Such threads are in a “runnable state” under the scheduler simulation program. For example, a first thread is running while a second thread made the pause( ) system call. Under the OS scheduler, the second thread will not be running. When executed by the scheduler simulating program, the second thread is in a “non-runnable state”.

A simulator of concurrent program behavior; a method of testing and debugging are disclosed below.

A multitasking computer operating system (OS) interleaves the execution of all existing processes. A user's program in general has no control over the process scheduling, which is done by the OS. Process schedules are affected by all kinds of asynchronous events occurring in the system. As a result, the flow of a concurrent application may vary from run to run, and that accounts for a class of computer bugs specific to such applications. These bugs may reveal themselves in certain execution flows, and may remain undetected in other execution flows.

The disclosed method of testing and debugging programs allows users to simulate the execution sequence and to run an application with full control of thread scheduling. Users will be able to reproduce and analyze any execution scenario. Thus, one valuable aspect of the tool will be in finding the exact sequence of events that precedes the failure, and being able to reproduce this sequence. A program may be tested a number of times. Developers will be able to reconstruct the timing of a test run in which a failure occurred, and successfully debug the program.

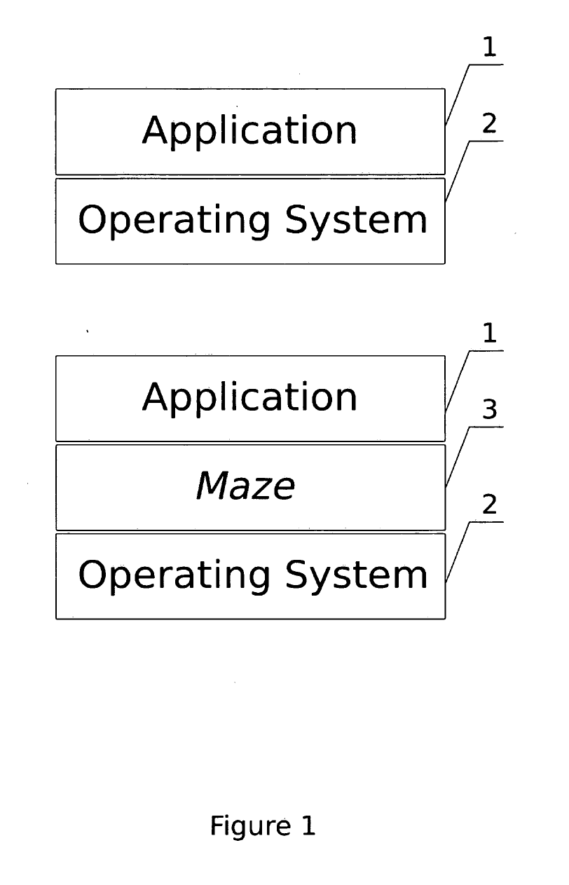

One aspect of the present invention is a tool for simulation of execution sequences. A great number of execution sequences exist, but only a few of them may reveal a intermittent bug. Hence, the invented tool has been appropriately named “maze”. As illustrated in FIG. 1, maze—a layer 3 between the running application 1 and the OS 2—takes control over scheduling of threads and processes in the application, and over of non-scheduling events. In repeated runs, the simulator generates various execution sequences, similar to those that occur in the real-world operation, when layer 3 is not present. If a bug is detected during a run, the simulator can reproduce the execution sequence exactly at any time.

An embodiment of the present invention has been implemented for X86 and X86-64 Linux platforms, and integrated into a tool for debugging and testing concurrent applications.

The difference between a process running on its own, and the process running under maze is in its scheduling with respect to other processes and threads within the same application. In the former case the schedule is affected by the number of, as well as states and priorities of all processes currently running on the machine. The resulting execution sequence cannot be controlled by user, it is unrecordable, and is not possible to reproduce.

When a process is controlled by maze, however, the schedule is not affected by any unrelated processes. It is deterministic, and it can be reproduced on request. If a process creates a child process or a thread, maze automatically takes control over the new process. If a process sends a signal to another process, maze takes control of signal delivery as well. Processes and threads of the application under test run, wait, or sleep following the maze directives.

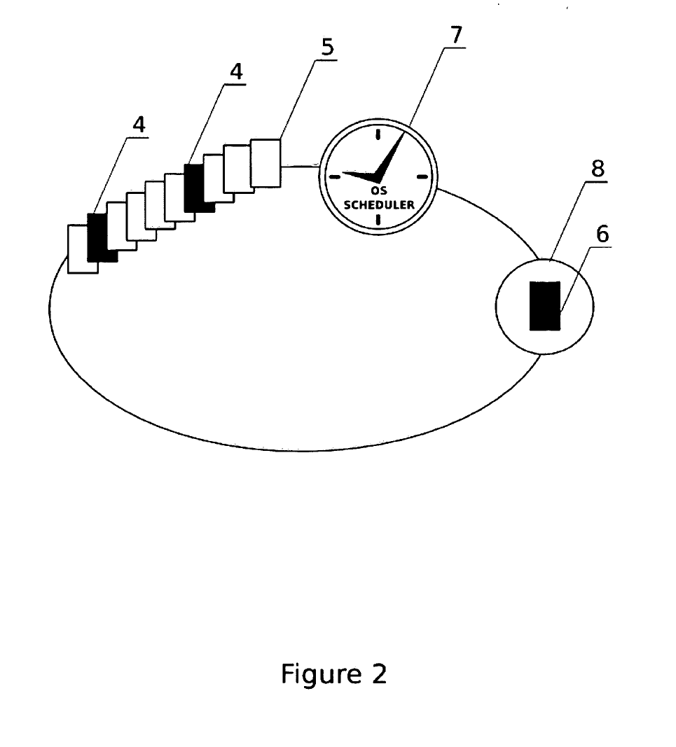

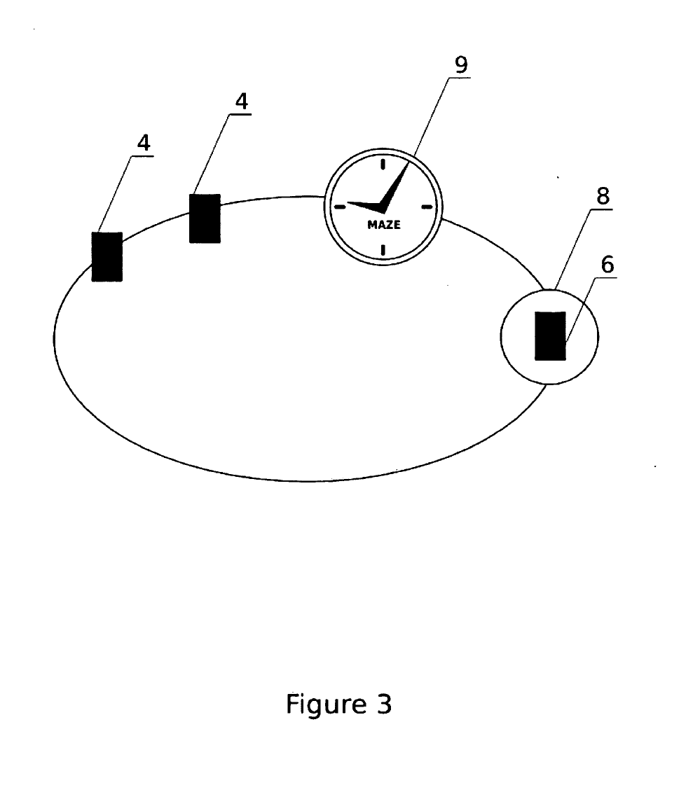

The distinction between an OS-controlled scheduling and maze-controlled scheduling is illustrated in FIGS. 2 and 3.

In FIG. 2, processes and threads 4 (represented by filled rectangles) of the AUT and other processes and threads 5 (represented by unfilled rectangles) are waiting for their turn to run, while a thread 6 of the AUT is running. The OS scheduler 7 grants threads and processes access to CPU 8. Access to CPU for threads of the AUT is given in an order that is affected by the state of the system: by the behavior of other processes and threads, changing priorities, asynchronous events.

In FIG. 3, access to CPU 8 for processes and threads 4, 6 of the AUT is fully controlled by maze 9. Therefore, the execution sequence during each run is known exactly.

Maze can run code under test multiple times, each time generating a unique execution sequence. This allows users to stress-test the code in a deterministic way, and catch hard-to-reproduce conditions, for example, race conditions, deadlocks, and segmentation faults. This mode of operation is called the “test” mode.

Maze can be run in a different mode of operation called the “reconstruction” mode. In this mode, maze runs user code once, reproducing the execution sequence from any single run taken from an earlier “test” mode session. “Reconstruction” may be done in batch mode or in interactive mode. In the interactive mode, a user may debug an AUT in a way similar to the way it is being done in a typical debugger: stepping through a process, setting breakpoints, inspecting values of variables; while AUT follows the execution sequence constructed in an earlier test run.

Besides taking control of process scheduling, maze simulates a part of non-deterministic OS behavior which affects the process by controlling OS events other than scheduling, for example but without limitation to: delivery of signals; user-process-scheduled events such as sleep, alarm.

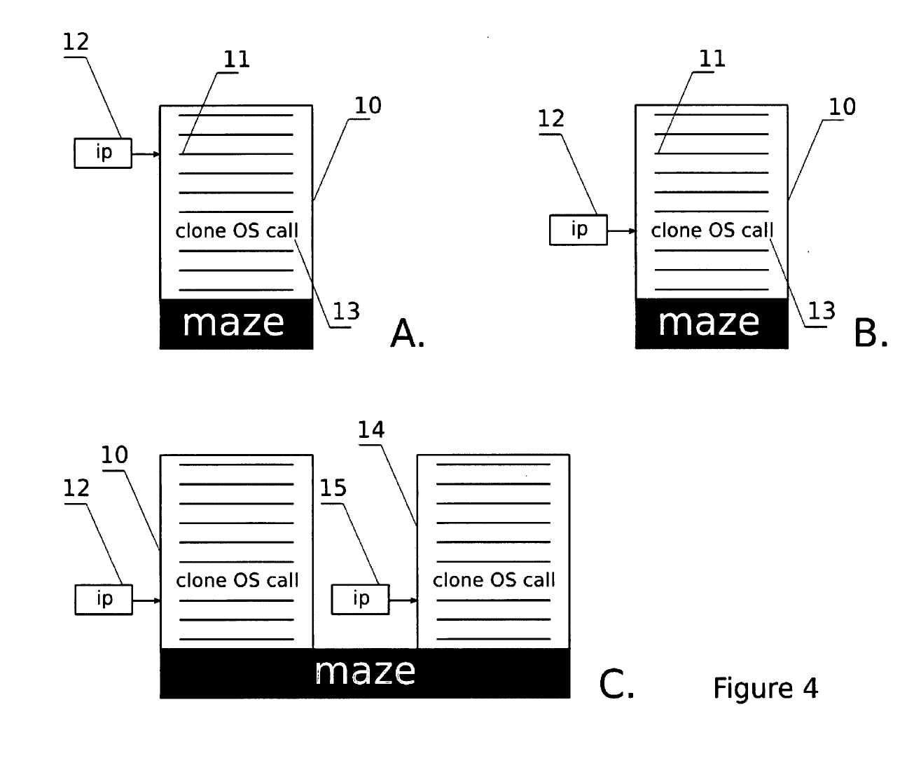

FIG. 4 provides an illustration of maze behavior in a situation when a process contains a syscall instruction resulting in spawning of another process. Maze works with compiled code at the lowest level, and does not care which particular high-level computer language the code was written in. To maze, the user code is a set of machine instructions which are to be executed. Maze controls the execution of a user code: a process can be suspended and resumed at any given machine instruction. In part A of FIG. 4 maze is shown to control a process 10, which is represented by a sequence of machine instructions 11. For ease of illustration, process 10 continues uninterrupted until it spawns a child process or a thread. Instruction pointer 12 moves down the instruction sequence 11 until it comes across an instruction 13 which is a system call resulting in a creation of a new process, as illustrated in part B of FIG. 4. Once the process has been cloned by the OS, maze takes control of the cloned process 14 (15 is the instruction pointer of the new process). From this point on, maze controls two processes: parent process 10 and child process 14, as illustrated in part C of FIG. 4. Maze is capable of interrupting execution of a process at any machine instruction and resuming execution of another process. Maze may, for example, run a certain number of instructions from process 10, then switch to process 14 and run a certain number of instructions from process 14, and so on.

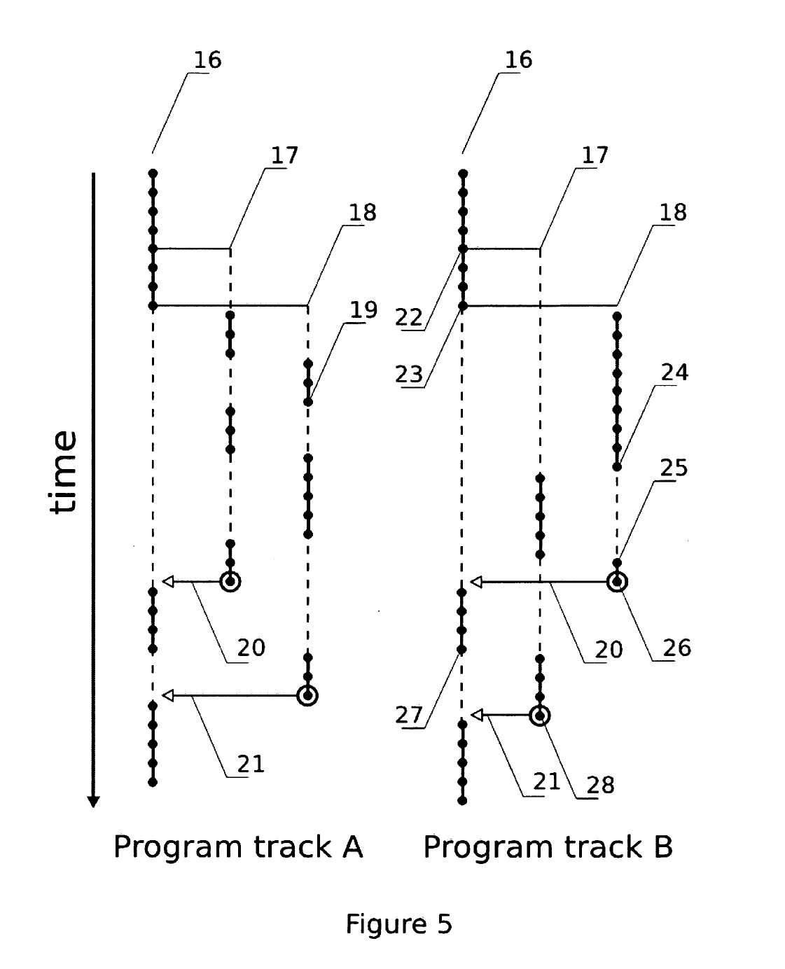

FIG. 5 provides an illustration of a bug specific to concurrent applications that maze is capable of catching and reproducing. In this FIG. 1 represent progression of processes along the sequence of machine instructions by solid vertical lines, with black circles representing machine instructions. A suspended process is represented by a dashed line.

A non-deterministic behavior of a multiprocess application run by the OS is obvious in FIG. 5: any of the three processes—parent 16, and children 17 and 18—can be preempted by the OS at any instruction, and another process will resume. For example, considering execution sequence A, at instruction 19 process 18 is suspended, at which point process 17 resumes. It is possible for child process 17 to end earlier than process 18 ends, as illustrated by execution sequence A. It is also possible for child process 18 to end earlier than process 17, as illustrated by execution sequence B. Assume, for example, an oversimplified case in which child processes each compute a number, and the parent process 16 is waiting for the two numbers to calculate the difference between the first computed number and the second computed number. A programmer makes an unjustified assumption that process 17 will always end before process 18 because process 17 was spawned earlier than 18 or because it is less computationally intense than 18. Indeed, the execution sequence A may be more likely than the sequence B, and most of the time the result of calculation will be as expected. But in some cases, program will execute in sequence B, and the result of the calculation will have the opposite sign.

Maze removes the non-determinism that arises from the possibility of child processes ending in different order. When maze controls the program execution, both sequences A and B are likely, but more importantly, if a maze-controlled program ran in sequence B—which led to an unexpected outcome—at least once during test runs, this execution sequence can be reproduced exactly during a reconstruction run.

To understand how maze constructs an execution sequence during a run, examine the progression of machine instructions in execution sequence B in FIG. 5. When maze runs a multiprocess application, it takes control of the execution, thus simulating a possible behavior of the application run by the OS. Referring to sequence B in FIG. 5: (i) maze decides to execute a number of user-space instructions of process 16; (ii) on executing several user-space instructions, maze comes across a system call instruction 22 to spawn a child process 17; (iii) maze lets the OS execute a system call to spawn a child process 17; (iv) maze decides to proceed with execution of process 16, decides on a number of instruction for process 16 to execute, preempts 17, and resumes parent process 16; (v) maze comes across a system call 23 to spawn a child process 18; (vi) maze lets the OS execute a system call to spawn a child process 18; (vii) maze decides to proceed with execution of process 18, decides on a number of instruction for process 18 to execute, and begins execution of this predetermined number of instructions; (viii) on executing instruction 24 which is the last of the predetermined number of instructions, maze preempts child process 18, decides to resume process 17, decides on a number of instructions for process 17 to execute, and resumes child process 17; (ix) maze preempts child process 17 after predetermined number of instructions, decides to execute a number of instructions from process 18, and resumes child process 18 at instruction 25; (x) maze executes the last instruction 26 from child process 18, upon which the OS sends “child process ended” signal 20 to the parent process 16; (xi) maze delivers signal 20 to parent process 16; (xii) on receiving signal 20, parent process 16 is resumed; (xiii) maze analyzes instruction 27, and determines that 27 is a “wait” system call, and preempts 16; (xiv) maze grants process 17 access to CPU, decides to execute a number of instructions from child process 17, and resumes process 17; (xv) child process 17 reaches the last instruction 28, upon which the OS sends “child process ended” signal 21 to the parent process 16; (xvi) maze delivers signal 21 to parent process 16 and proceeds with its instructions.

I have just detailed the procedure of construction by the simulator of just one possible execution sequence. A person ordinarily skilled in the art of computer programming will appreciate that many other execution sequences are realizable: the simulator can decide to run a different number of instructions to execute before preemption; it may also choose differently which process to suspend and which to proceed with on spawning a child process.

The simulator chooses repeatedly throughout the simulation of OS scheduling the number of machine instructions to execute before preemption. It should be pointed out that it is not known a-priori that the entire chosen number of instructions will be executed because the simulator may encounter a system call instruction, the execution of which may result in the process blocking. In this case, maze preempts such process.

One aspect of simulation of the OS scheduling is a preferred method of forming and saving an execution sequence. At the beginning of each test run, the simulator saves the state of a pseudo-random number generator (RNG). A state of the RNG completely defines the sequence of pseudo-random numbers that are generated in repeated calls to RNG. The simulator uses the RNG sequence for process scheduling: a pseudo-random number determines which process is running next, and how many machine instructions to execute before preempting the process and resuming another process. During a test run, the simulator repeatedly requests random numbers from the RNG to construct an execution sequence for this run. Having saved the state of RNG at the beginning of the run, the simulator is capable of reproducing the entire execution sequence on demand.

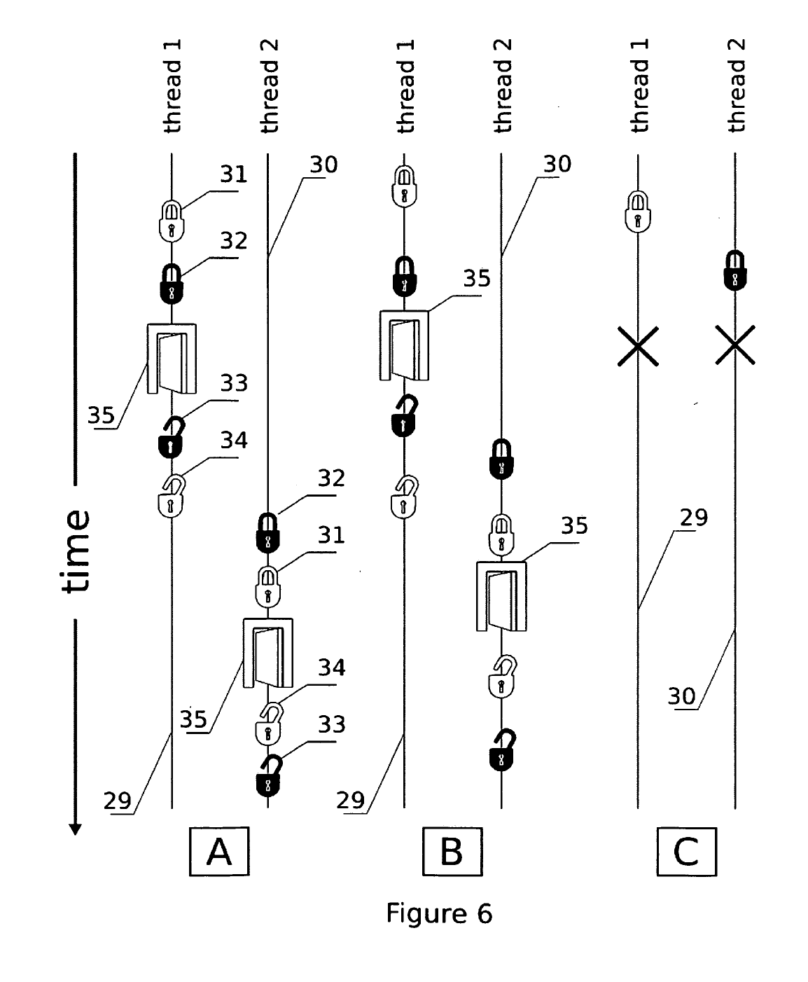

A method of testing and debugging disclosed herein is capable of catching different types of bugs specific to concurrent applications. For example, the simulator is capable of finding a deadlock condition. In the illustration provided in FIG. 6, two threads of an application, 29 and 30, run concurrently. When the simulator is controlling the execution, the execution sequence during each run is known and can be reproduced at a later time. In this example, three execution sequences A, B, and C were among those constructed by the simulator in test runs. In order to gain access to a protected resource, a thread must obtain 2 mutexes. In FIG. 6 the mutexes are represented by black and white locks, and access to the resource is represented by an open door 35. In sequence A of FIG. 6, a first thread 29 acquires 31 “white” mutex, then acquires 32 “black” mutex, gains access to the protected resource, then releases 33 “black” mutex, then releases 34 “white” mutex. A second thread 30 acquires and releases mutexes in a different order: it acquires “black” 32, acquires “white” 31, gains access to the resource, releases “white” 34, then releases “black” 33. The timing of acquisitions and releases of mutexes is such that each thread at some point gains access to the resource.

Execution sequence C, however, results in a deadlock: the first thread acquired “white” mutex, while the second thread acquired “black” mutex, and both threads are waiting to acquire the other mutex. When such process is running on its own, it blocks. When such process is traced by a conventional debugger, it blocks and also suspends the execution of the debugger's process. In both cases, a user has to interrupt the blocked process manually. In contrast, when such process it run by the simulator, it detects the deadlock condition; collects and reports, for example, the process stack, contents of registers, other diagnostic information; and does not block.

An important aspect of the invention is a non-blocking method of program execution. The simulator anticipates possible blocking by examining system call instructions. For example, each time a thread is about to execute a system call instruction to acquire a mutex, the simulator verifies the availability of the mutex, and allows the thread to proceed with system call execution only if the mutex is available. Otherwise, the simulator suspends the thread at the “entrance” to kernel space, and grants another thread access to CPU.

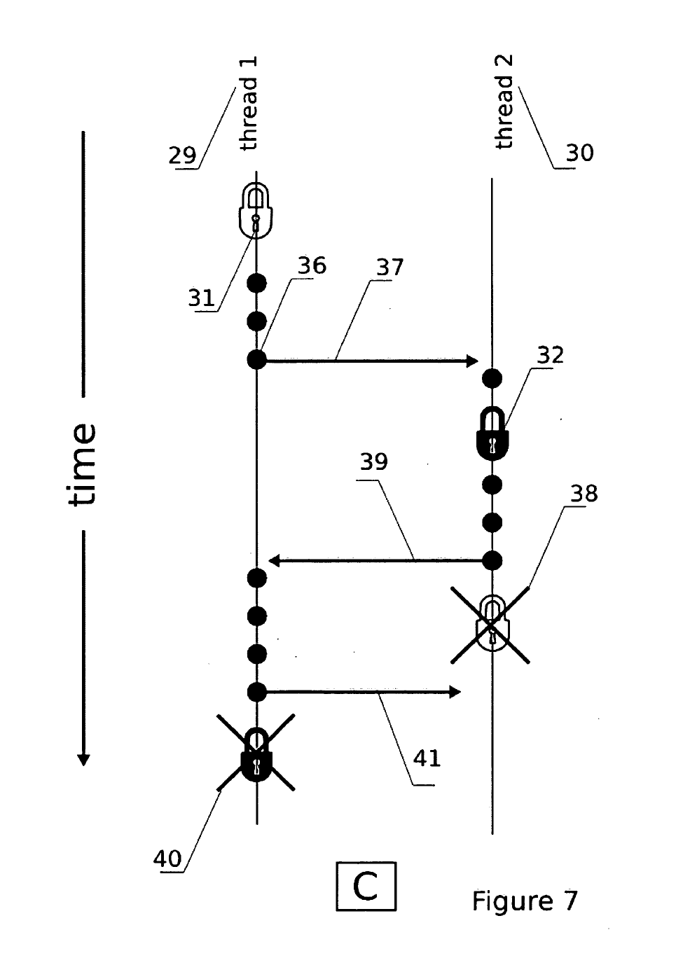

Sequence C from FIG. 6 is presented in more detail in FIG. 7, which is provided for illustration of the non-blocking method. Referring to FIG. 7: (i) the simulator allows thread 29 to acquire 31 the “white” mutex after verifying its availability; (ii) after executing a simulator-scheduled number of machine instructions, at instruction 36, the simulator switches preemptively 37 from thread 29 to thread 30; (iii) the simulator allows thread 30 to acquire 32 the “black” mutex after verifying its availability; (iv) after a number of instructions, the simulator encounters a system call instruction in thread 30 to acquire “white” mutex; (v) the simulator checks availability of “white” mutex, and does not allow mutex acquisition 38, because “white” mutex had been acquired by thread 29; (vi) unable to proceed with thread 30, the simulator suspends thread 30 and switches 39 to thread 29 where, after a number of machine instructions, the simulator encounters a system call instruction to acquire “black” mutex; (vii) the simulator does not allow mutex acquisition 40 because “black” mutex had been acquired by thread 30; (viii) unable to proceed with thread 29, the simulator suspends thread 29 and switches back 41 to thread 30, where it cannot proceed either. The simulator determines that it can no longer proceed in either thread, thereby detecting a deadlock.

Several important aspects of the invented method of simulation of the OS scheduler were illustrated in FIGS. 5 through 7. The simulator performs preemptive scheduling. The simulator also handles non-scheduling events: for example, system call instructions to acquire mutexes in FIGS. 6 and 7, and interprocess signals in FIG. 5. Blocking anticipation illustrated in FIG. 7 enables non-blocking program execution. Non-blocking execution is obviously necessary for completion of every constructed execution sequence, and for obtaining run outcome and debugging information.

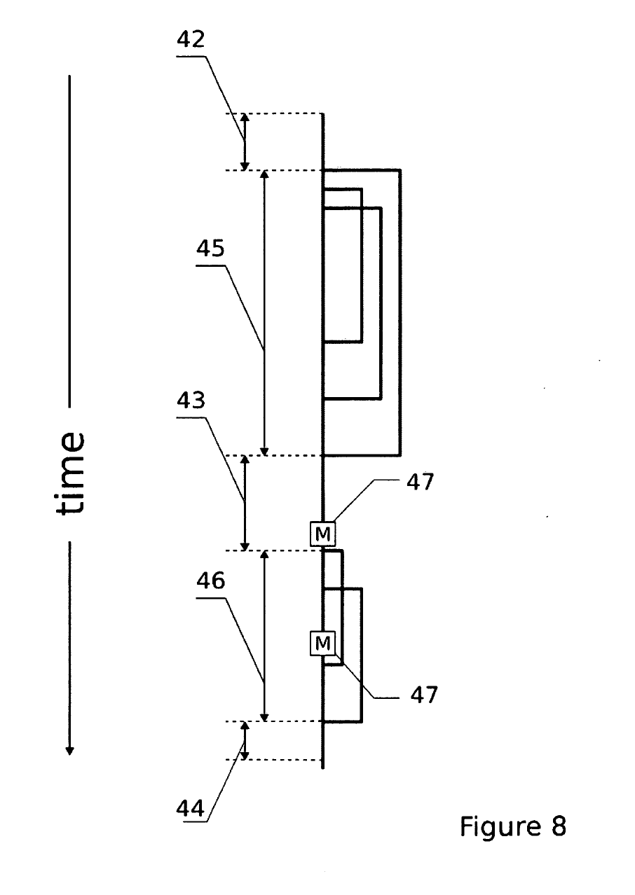

Another aspect of the invention is a method of performing scheduling of application execution by the simulator when more than one process or thread are runnable concurrently, while not performing scheduling when no more than one thread or process is runnable, as illustrated in FIG. 8. Processes are represented by bold lines. During execution flow intervals 42, 43, and 44, a single process of the application is being executed. During these intervals the simulator does not perform deterministic scheduling, but does monitor system calls. As soon as a new thread of process is created, the simulator begins scheduling of the execution of all running processes, for example, at the start of intervals 45 and 46. The simulator also allows a user to mark any intervals of interest during which the simulator should perform deterministic scheduling, for example, a user may want the simulator to perform scheduling only during an interval within user-defined marks represented by a letter “M” 47.

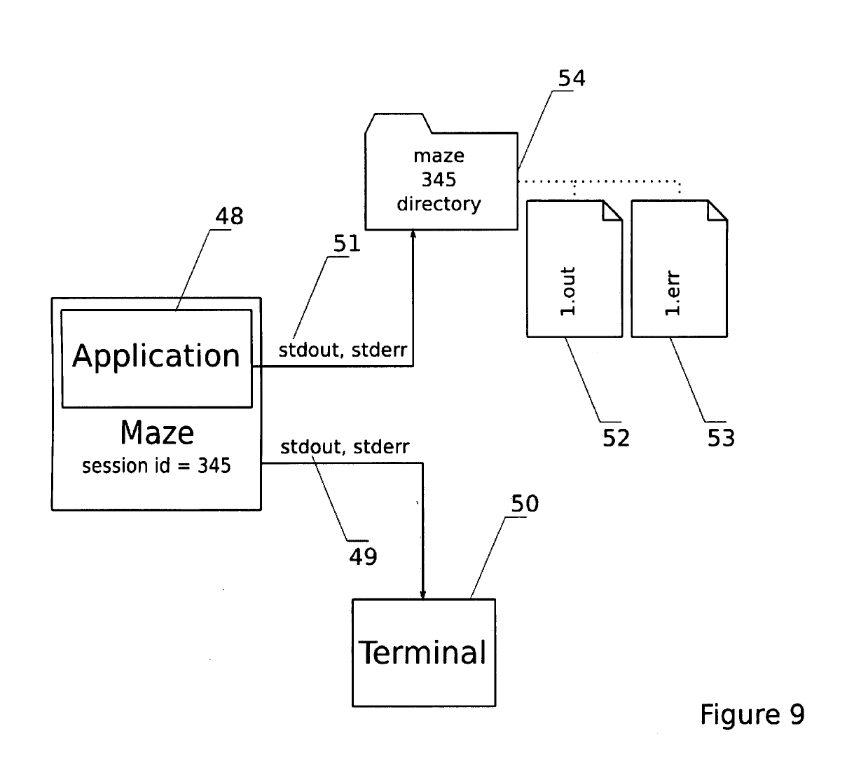

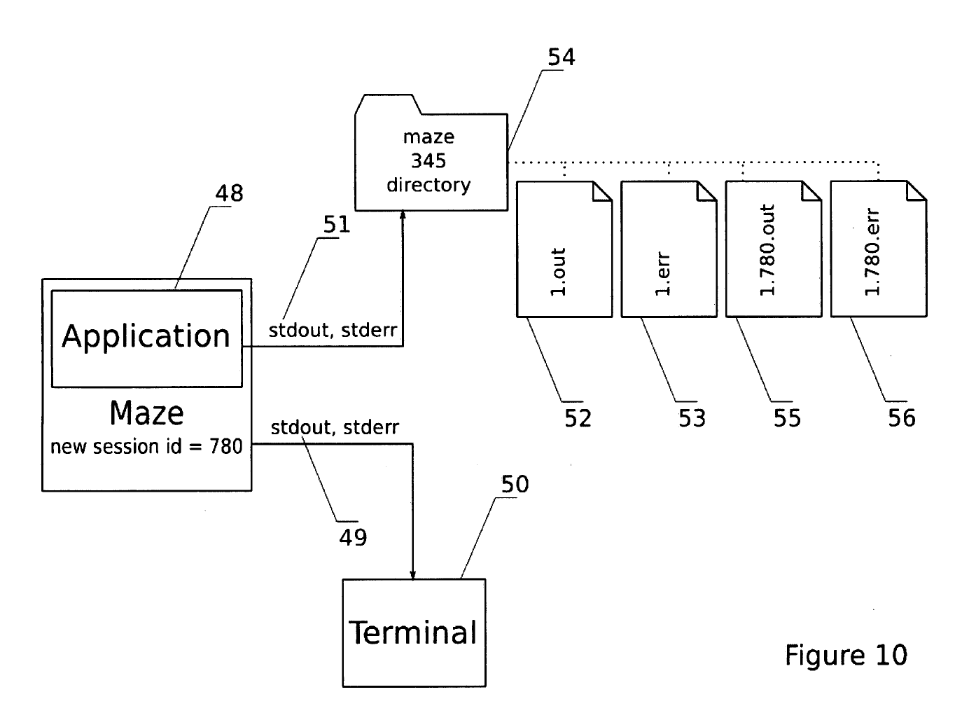

Another aspect of the present invention is a method of forming and presenting a run outcome. An embodiment of a method of forming and presenting a run outcome is described by referring to FIGS. 9 and 10. This description is not meant as a limitation; many other embodiments of a method of forming and presenting a run outcome are consistent with the method of the present invention.

Referring to FIG. 9, when an AUT 48 is run by maze in “test” mode, the simulation program's own standard output and error streams 49 are forwarded to the terminal 50. To allow the user examine results of each run separately, the simulator redirects the AUT's standard streams 51 to files 52, 53 identified by run id, created under a the simulator session directory 54 identified by the simulator session id (in this example, session id is 345). As illustrated in FIG. 9, files 52 and 53 contain standard streams from run with id=1.

Referring to FIG. 10, the run outcome in “reconstruction” mode is presented according to a particular run from the simulator session that a user wants to reconstruct. For example, the user may want to reconstruct the run with id=1 from the simulator session with id=345. The AUT's standard streams from that run were stored in directory 54. In reconstruction session, which is a new simulation session with a new id (in this example the new id=780), standard streams of the AUT are saved in the same directory 54. The files containing these streams 55, 56 are identified by the test run being reconstructed, and the reconstruction session id, and their names are formed as <run id>.<reconstruction session id>.out and <run id>.<reconstruction session id>.err.

In another embodiment, the simulation program's own standard output and error streams 49 represented in FIGS. 9 and 10 may be saved to files or stored as database records. Maze may also store the AUT's standard streams 51 as database records identified by run id, the simulator test session id, the simulator reconstruction session id.

An exemplary user application—a C program implementing mutex acquisitions by two threads—with a possible deadlock condition is represented in Exhibit I. A result of deterministic stress-testing of such application according to an embodiment of this invention is represented in Exhibit II. Each of two threads of an AUT locks and then unlocks two mutexes. The first thread acquires mutexes in the order (mutex_{—}1, mutex_{—}2), while the second thread acquires them in the opposite order: (mutex_{—}2, mutex_{—}1). Depending on timing two threads may run into a deadlock: the first thread has acquired mutex_{—}1 and is waiting for the mutex_{—}2, while the second thread has acquired mutex_{—}2 and is waiting for the mutex_{—}1.

Referring to Exhibit I, function “do_mutexes” defined in lines 38 through 52, is a exemplary way to implement mutex transactions. An illustration of such transactions was provided in FIG. 6: mutex acquisitions are represented by 31, 32; and releases by 33, 34. A new thread created in line 27 executes “do_mutexes” concurrently with the main thread.

Referring to Exhibit II, a user compiles the code in Exhibit I and starts the simulator in “test” mode (as shown in line 101). In this example, the simulator executes the code 100 times. In lines 102 through 104, the simulator's standard error output lets the user know that 3 of 100 runs resulted in a deadlock. In line 105, a user starts the simulator in reconstruction mode to reproduce the deadlock condition in run number 95. Maze's standard output directed to the terminal begins at line 107. In this example, run outcome information presented to a user comprises: identification of deadlock condition in line 126; identification of blocking processes in lines 128 and 134; and the stacks of blocking processes in lines 129 through 133, and in lines 135 through 141.

CODE LISTING 1
Exhibit I An exemplary user application implementing mutex
acquisitions by two threads

//------------------------------------------------------------------------------
//
//
// deadlock.c
//
//------------------------------------------------------------------------------

| | |
|---|---|
| #include <assert.h> | // for assert |
| #include <pthread.h> | // for pthread_create |

```
static void do_mutexes(pthread_mutex_t * mutex_1, pthread_mutex_t *
mutex_2);
static void * simple_thread(void *);
static pthread_mutex_t blue, grey;
int main( )
{
  pthread_t tid = 0;
  // initialize mutexes
  int error = pthread_mutex_init(&blue, 0);
  assert(error == 0);
  error = pthread_mutex_init(&grey, 0);
  assert(error == 0);
  // create a thread
  error = pthread_create(&tid, 0, &simple_thread, 0);
  assert(error == 0);
  do_mutexes(&blue, &grey);
  error = pthread_join(tid, NULL);
  assert(error == 0);
  return 0;
}
static void do_mutexes(pthread_mutex_t * mutex_1,
    pthread_mutex_t * mutex_2)
{
```

| | |
|---|---|
| int error = pthread_mutex_lock(mutex_1); | // acquire mutex_l |

assert(error == 0);

| | |
|---|---|
| error = pthread_mutex_lock(mutex_2); | // acquire mutex_2 |

assert(error == 0);

| | |
|---|---|
| error = pthread_mutex_unlock(mutex_2); | // release mutex _2 |

assert(error == 0);

| | |
|---|---|
| error = pthread_mutex_unlock(mutex_1); | // release mutex _1 |

```
  assert(error == 0);
}
static void * simple_thread(void * dummy)
{
  do_mutexes(&grey, &blue);
  return NULL;
}
```

CODE LISTING 2
Exhibit II A standard output formed according to an embodiment of the invention, comprising
information on an unexpected outcome of an execution of an exemplary user application
of Exhibit I.

```
$ maze ./deadlock −r 100 > /dev/null
maze: ERROR: A deadlock was detected in the run # 17.
maze: ERROR: A deadlock was detected in the run # 63.
maze: ERROR: A deadlock was detected in the run # 95.
$ maze −R 95
**********************************************************************
*
* Running maze, a concurrent programming development tool
*
*
* This is a 64 bit version 1.0-beta-2010.04.14.
*
**********************************************************************
  Running in a reconstruction mode.
    -------------------------------------------------------------------------------
    Reproducing run # 95 from the maze test session with pid =11231.
    -------------------------------------------------------------------------------
    Run # 95
    stdout > “/home/someuser/.maze/11231/95.11462.out”
    stderr > “/home/someuser/.maze/11231/95.11462.err”
    The following process is running:
    pid command
    11470 /home/someuser/deadlock
    A new thread (tgid = 11470, pid = 11471) created by Main thread (tgid = 11470, pid =
11470)
    ERROR: A deadlock was detected in the run # 95.
    The following processes are blocking:
    Main thread (tgid = 11470, pid = 11470) is waiting for a mutex.
    #0 0x34bd40d742 in _lll_lock_wait ( ) from /lib64/libpthread-2.8.so
    #1 0x34bd408ee4 in _L_lock_100 ( ) from /lib64/libpthread-2.8.so
    #2 0x34bd408901 in pthread_mutex_lock ( ) from /lib64/libpthread-2.8.so
    #3 0x400802 in do_mutexes (mutex_1 = 0x600d20, mutex_2 = 0x600d60) at deadlock.c:49
    #4 0x400787 in main ( ) at deadlock.c:35
    Thread (tgid = 11470, pid = 11471) is waiting for a mutex.
    #0 0x34bd40d742 in _lll_lock_wait ( ) from /1ib64/libpthread-2.8.so
    #1 0x34bd408ee4 in _L_lock_100 ( ) from /lib64/libpthread-2.8.so
    #2 0x34bd408901 in pthread_mutex_lock ( ) from /lib64/libpthread-2.8.so
    #3 0x400802 in do_mutexes (mutex_1 = 0x600d60, mutex_2 = 0x600d20) at deadlock.c:49
    #4 0x400897 in simple_thread (dummy = 0) at deadlock.c:62
    #5 0x34bd40729a in start_thread ( ) from /lib64/libpthread-2.8.so
    #6 0x34bc8e439d in _clone ( ) from /1ib64/libc-2.8.so
    Run # 95 completed with 1 error.
    -------------------------------------------------------------------------------
```

I claim:

1. A method of executing a software application, comprising:
giving a command to execute a predetermined number of instructions from said executable,
preempting a thread of the executable at an instruction,
controlling operating system calls.

2. The method of claim 1 further comprising controlling transitions of thread executions from user space to kernel space.

3. The method of claim 1 further comprising selecting a thread to run from a plurality of runnable threads.

4. The method of claim 1 wherein said application is uninstrumented.

5. The method of claim 1 further comprising controlling interprocess communications.

6. The method of claim 1 further comprising controlling one or more interrupts.

7. The method of claim 1 further comprising controlling one or more from the group: delivery of signals between an operating system and a thread, delivery of signals between an operating system and a process, delivery of signals between processes or threads, a thread blocking, spawning a process, completion of a process, spawning a thread, completion of a thread.

8. The method of claim 1 further comprising executing instructions without preemption if there is no more than one thread in a runnable state within the application.

9. The method of claim 1 further comprising:
determining that an instruction will transfer a thread of said application to kernel space;
determining that, if execution of the instruction is allowed, the thread will block;
stopping the thread before execution of said instruction.

10. The method of claim 1 further comprising:
determining that an instruction will transfer a thread of said application to kernel space;
determining that, if execution of the instruction is allowed, the thread will not block;
and continuing execution of the thread.

11. The method of claim 1 further comprising selecting a part of the application for scheduling, and performing scheduling of the part.

12. A method of testing a computer code, the method comprising obtaining an outcome of at least one reproducible execution sequence, the sequence comprising operating system calls and executed machine instructions of said code.

13. The method of claim 12 wherein the sequence further comprises one or more notification of an interrupt.

14. The method of claim 12 wherein said outcome is obtained in the absence of instrumentation of said code.

15. The method of claim 12 wherein obtaining said sequence comprises giving a command to execute a predetermined number of instructions from said code; preempting a thread at an instruction; making a selection of a thread to run from a plurality of runnable threads.

16. The method of claim 12 further comprising recording information required to reproduce said sequence.

17. The method of claim 12 further comprising using a pseudo-random number generator for creation of said sequence, and recording a state of said generator.

18. The method of claim 12 wherein said outcome comprises one or more of: program output, process flow diagnostic information, a thread stack, content of registers, an abnormal event information, a reason for a thread blocking.

19. The method of claim 12 further comprising: determining that an instruction will transfer a thread to kernel space; determining whether the thread will block upon execution of the instruction; stopping the thread before execution of said instruction if determined that the thread will block upon execution of the instruction; continuing execution if determined that the thread will not block upon execution of the instruction.

20. A method of executing a concurrent computer application, the method comprising obtaining a plurality of outcomes of reproducible execution sequences, a sequence comprising executed machine instructions from said application and operating system calls; the method further comprising selecting an outcome from said plurality for examination.

21. The method of claim 20 further comprising executing one or more times the sequence for which said outcome was obtained.

22. The method of claim 20 wherein an outcome of said plurality comprises one or more of: the application output, process flow diagnostic information, a thread stack, content of registers, an abnormal event information, a reason for a thread blocking.
